(19) United States
(12) Patent Application Publication
(10) Pub. No.: US 2009/0076861 A1
(43) Pub. Date: Mar. 19, 2009

(54) INVESTMENT STYLE LIFE INSURANCE PRODUCT WITH REPLACABLE INDIVIDUAL POLICY COMPONENTS

(75) Inventor: Robert Miles Saunders, Westfield, NJ (US)

Correspondence Address: MAYER & WILLIAMS PC, 251 NORTH AVENUE WEST, 2ND FLOOR, WESTFIELD, NJ, 07090, US

(73) Assignee: RMS HOLDING CO., LLC, Westfield, NJ (US)

(21) Appl. No.: 12/211,055

(22) Filed: Sep. 15, 2008

Related U.S. Application Data
(63) Continuation-in-part of application No. 09/849,297, filed on May 4, 2001, now abandoned.

(51) Int. Cl. G06Q 40/00

(52) U.S. Cl. 705/4

(57) ABSTRACT

The present invention includes a data model which supports database operations that are associated with an insurance product issued by an issuer that provides a consumer with an ability to purchase an investment style life insurance policy, the individual components of which (e.g., term insurance, investments, cash and fees) can be controlled and/or replaced by the consumer. The data model enables the individual components to be tracked by the issuer so that the correct insurance coverage and investment returns are provided (and appropriate fees levied) as the consumer makes changes to the individual insurance policy components.

### STATEMENT OF RELATED APPLICATION

This application is a continuation-in-part of commonly assigned, co-pending U.S. patent application Ser. No. 09/849,297, filed May 4, 2001, and entitled “Investment Style Life Insurance Product That Allows Consumer To Control and Replace Individual Policy Components”, which is incorporated by reference herein in its entirety.

### BACKGROUND

Generally, there are two types of life insurance. The simplest form is Term Life Insurance, which is a contract between the insured and the issuer in which the issuer agrees to pay a face amount to a named beneficiary on the insured's death in return for periodic premium payments by the insured to the insurer. Term Life Insurance is generally sold for fixed periods, such as one, ten, fifteen, twenty or thirty years (or one to thirty), during which period the premiums are often level or fixed. These premiums are usually based on mortality tables and/or actuarial data available to the issuer at the time of issuance. Therefore, changes in the mortality tables and/or actuarial data do not usually change the premiums over the period of the policy, even if the changes are favorable to the issuer. Historically, the changes have been favorable to the issuers, however, generally, the issuers do not pass these savings on to the consumer.

At the end of the initial period, depending on the conditions of the policy, there are several possible outcomes. First, the policy may terminate, in which case the policy has no further value. Alternatively, the policyholder may choose to have a policy that is renewable on a periodic basis, e.g., yearly. Or, the policyholder may have an option to convert the policy into an “Investment Style” form of life insurance, some common forms of which include Whole Life, Variable Life or Universal Life.

For short time periods, Term Life Insurance is usually less expensive than Investment Style Life Insurance. In addition, being less complex Term Life Insurance is easier for customers to comparison shop for the most economical product. Moreover, Term Life Insurance can typically be converted into Investment Style Life Insurance. Hence, if there are health, underwriting or actuarial changes in the insured's status the insured can elect this option. Furthermore, should policy prices decrease it is possible to replace a Term Life Insurance policy with a new one at a lower price without incurring significant costs to do so. Depending upon the value of the policy, a new underwriting may apply.

Unfortunately, Term Life Insurance has no objective value so long as the insured is alive. Of course, a Term Life Insurance policy may have some value in a market in which the insured had locked in a particularly low rate and the actuarial data indicated an upward movement in insurance costs, however, this generally has not to date occurred, and the trend in fact has been in the opposite direction. Moreover, a policy holder of term life insurance may be able to sell his policy in certain cases for cash if the policy holder contracts a deadly disease and the purchaser is willing to trade the cash now for a payment of the death benefit later. But other than these relatively rare instances, Term Life Insurance has little objective value.

Term Life Insurance may have a subjective value at least to some people, i.e., the insured has the comfort of knowing his beneficiary will receive the face amount at his death, which face amount is often selected to provide for the beneficiary in the absence of the insured being able to provide. Nevertheless, if the policyholder outlives the term of the policy, the policy becomes worthless in that the holder has nothing to show for the years of premium payments, other than the subjective comfort during that period. For longer terms, premiums rise significantly, e.g., for a fifty year old male, a twenty year policy may have premiums twice that of a ten year policy and a thirty year term may have premiums thrice that of a ten year policy.

Another general form of life insurance is a combination of investment and life insurance. “Investment Style” Life Insurance comes in many forms, including for example, Universal Life, Whole Life, Flexible Life and Variable Life. We shall use the term “Combination Investment/Life Insurance” to refer to it herein. Combination Investment/Life Insurance is considerably more complex than Term Life Insurance in that, integrated into the policy is an investment vehicle that has the potential of increasing in value, providing an income flow and/or serving as security for a loan. These added features come, however, at a price, in dollars and complexity.

Because of the variations in investments and fees it also becomes extremely difficult to compare policies. Due to the complexity of the transactions, up front fees are charged the insured at the time of issue; some of these fees are quite large and immediately detract from the amount of the funds available for investment. As the investment is selected to generate increased value there are federal and state tax considerations on the increased value if and when it is paid to the policyholder. In addition, there may be periodic management fees. Moreover, such policies often include additional surrender charges.

As with any investment it is difficult to predict the income stream, if any, given the variation in the asset value over time and the expected value of the investment for several years in the future. Consequently, purchasers of this type of insurance often pay more than they would pay if they could easily comparison shop. Moreover, once one obtains such a policy, the cost to terminate these policies effectively locks the policyholder into the policy for many years due to the up front charges and surrender charges mentioned above.

The advantages of Combination Investment/Life Insurance over straight Term Life Insurance is that at any point in time the Combination Investment/Life Insurance policy has a cash value and therefore may serve as security for a loan. Moreover, the cash value is expected to increase over time as the underlying asset increases in value. In addition, the U.S. Internal Revenue Code offers certain tax benefits, including tax deferral or no taxation at all on income and capital appreciation. Furthermore, Combination Investment/Life Insurance policies are typically permanent in nature, at least to age 100.

The disadvantages to the policyholder of Combination Investment/Life Insurance include its relatively high premium cost per dollar death benefit when compared directly with Term Life Insurance. In addition, the large commissions paid upfront out of the initial investment significantly reduce the amount of funds available for investment. The policy purchaser has great difficulty comparing competing policies to determine the true cost of insurance. Moreover, if the policy is terminated prematurely there are significant premature withdrawal penalties plus an additional ten percent income tax penalty. Finally, if the market price for basic insurance goes down the high initial costs preclude the policyholder from taking advantage of all but the most drastic changes in price in order to obtain lower premiums.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

The present invention solves these and other problems by providing a data model which supports database operations that are associated with an insurance product issued by an issuer that provides a consumer with an ability to purchase an investment style life insurance policy, the individual components of which (e.g., term insurance, investments, cash and fees) can be controlled and/or replaced by the consumer. The data model enables the individual components to be tracked by the issuer so that the correct insurance coverage and investment returns are provided (and appropriate fees levied) as the consumer makes changes to the individual insurance policy components.

According to one illustrative example of the present invention, a consumer first purchases a term life insurance policy. This term life insurance policy can be purchased from any source, including the issuer of the investment style life insurance policy. Ownership over this term life insurance policy is then transferred to the issuer of the investment style life insurance policy. The transfer enables the recipient (i.e., the issuer) to receive any and all benefits under the term life insurance policy. In return, the issuer issues an investment style life insurance policy to the consumer whose insurance amount equals the face amount of the term life insurance policy originally held by the consumer.

According to other illustrative examples of the present invention, the consumer may also transfer other assets/rights/liabilities to the issuer along with the term life insurance policy. In return, the issuer issues an investment style life insurance policy whose underlying investments include the same or similar assets/rights/liabilities. Thus, the consumer can control (and even change) the type of assets/rights/liabilities underlying the investment style life insurance policy.

According to yet another illustrative example of the present invention, the issuer charges a flat fee for the transaction, which flat fee is not based on actuarial data. Other potential fee arrangements could include fees based on a percentage of the assets or a percentage of the policy value. Because the issuer reissues a reciprocal (or investment style) life insurance policy to the consumer, there is no need for the issuer to perform actuarial calculations. Moreover, as term life insurance rates decrease, the consumer can replace the life insurance component with a more inexpensive policy, thereby ensuring the consumer is always capable of receiving the best term life insurance rates available.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 depicts an exemplary embodiment of a method according to one aspect of the present invention;

FIG. 2 depicts an exemplary embodiment of a method according to another aspect of the present invention;

FIG. 3 depicts a block diagram of an exemplary embodiment of a first transaction type according to one aspect of the present invention;

FIG. 4 depicts a block diagram of an exemplary embodiment of a second transaction type according to another aspect of the present invention;

FIG. 5 depicts a block diagram of an exemplary embodiment of a third transaction type according to another aspect of the present invention;

FIG. 6 shows an architecture that supports electronic communication between the various elements that may be used in the present invention; and

FIG. 7 shows an application programming interface (“API”) and data model that is exposed by a database server used by an insurance company.

Like reference numerals indicate like elements in the drawings.

### DETAILED DESCRIPTION

Any reference herein to “one embodiment” or “an embodiment” means that a particular feature, structure, or characteristic described in connection with the embodiment is included in at least one embodiment of the invention. The appearances of the phrase “in one embodiment” in various places herein are not necessarily all referring to the same embodiment.

As used herein, assets, rights or liabilities refers to any tradable commodity or item of value in which there exists a market, however small, for trading. This definition includes both instruments and non-instruments. Examples of instruments include without limitation: securities, equities, bonds, futures, mutual funds, derivatives, currencies (both national and foreign), fungible commodities, insurance contracts, mortgages, bonds, high-yield debt, foreign debt, convertible debt, notes, pollution rights, development rights, leases, loans, real estate investment trusts, etc. Examples of non-instruments include without limitation: airline reservations, hotel reservations, timeshare rights, golf tee times, country club memberships, antiques, telecommunications bandwidth, factory capacity, real estate, consumer coupons, airline miles, hotel miles, consumer reward program credits, etc. Although the methods of the present invention described herein can be used for any asset or liability, for brevity purposes the discussion herein relates primarily to its use in connection with instruments or securities.

The present invention includes a system for matching and tying an asset owned by the investor-consumer with an insurance policy providing a specified death benefit, which policy requires the payment of premiums either on a periodic basis or a single payment basis. These premiums may be paid from the revenue generated by the aforesaid asset. Alternatively, the premiums may be paid up front for the entire period, or from the principal of the asset. The investment returns obtain the tax benefits of a combination investment/life insurance product.

By combining the asset, the asset's return and the insurance policy in this manner the consumer's real cost for the insurance is, in most cases, cut significantly. In point of fact, the cost of the insurance is cut in two ways. First, the most inexpensive term insurance available from reputable insurers is obtained. Second, the cost may be paid with pre-tax money. Moreover, as the cost of insurance decreases, the term insurance can be re-purchased at the new lower costs, thereby further decreasing the cost of the insurance, which savings can either be passed on to the consumer or retained by the issuer as additional profit.

The present invention eliminates the disadvantages and costs of the current process for issuing Combination Investment/Life Insurance while providing the consumer the advantages of investment growth and tax savings of investment-tied insurance at almost the price of term insurance, as well as giving the insured the flexibility to easily avail himself of future declines in the price of insurance, at an initial cost only slightly above of that of Term Insurance.

The present invention allows the issuer of Combination Investment/Life Insurance to issue a policy that is tied to an asset the income from which would be used to, in whole or in part, before taxation to policyholder, pay the premiums on the policy on the customers life in a denominated amount in for fixed period of years at substantial savings through the unique process of obtaining term insurance as the same face amount the Whole Life insurer as beneficiary.

This process also allows the customer to take advantage of decreases in premiums, as there is virtually no cost to replace term insurance while there are significant costs to replace Whole Life policies.

The present invention provides various processes for issuing combination investment/life insurance policies, some of which are set out here by way of example. Parts of the various processes set forth below can be combined with other parts of other processes to form various combinations. Moreover, the following processes can be implemented via computer to automate the described transactions. For example, each transaction could be performed via a user's personal computer accessing a server via the Internet in standard client-server architecture. While the following transactions refer to exchanges between insured and issuers, these exchanges could be performed in an automated manner.

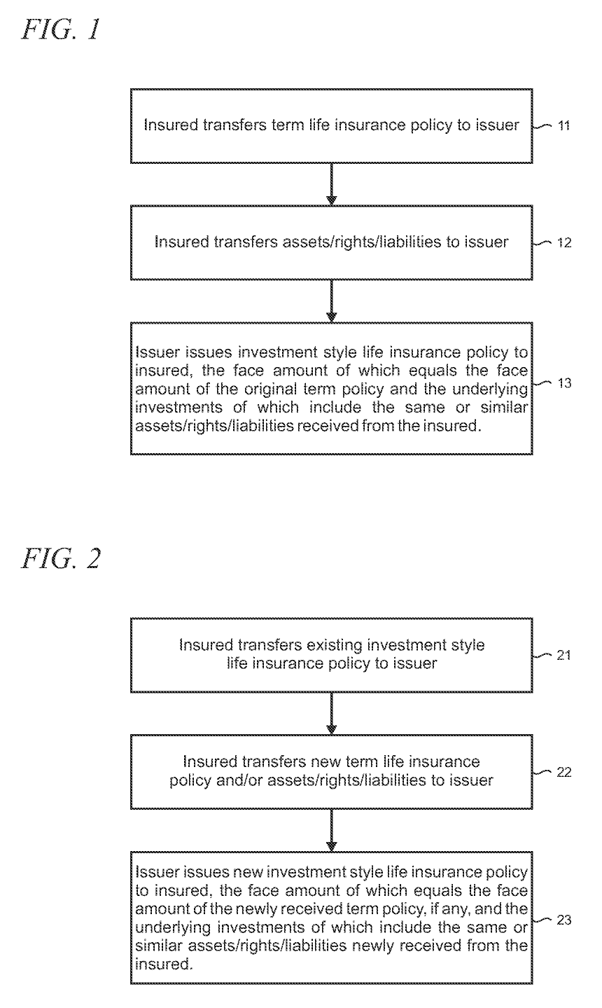

Referring to FIG. 1, in the first exemplary embodiment 10 the insured already owns an existing term life insurance policy, as well as one or more assets, rights and/or liabilities. In this case, the insured wishes to obtain an investment style life insurance policy, e.g., a Combination Life Insurance/Investment Policy. To do so, the insured transfers the term life policy to the issuer (as indicated by reference numeral 11). This transfer can be accomplished in several ways. For example, the insured can designate the issuer as the owner and/or beneficiary of the existing term life insurance policy. Once the transfer is complete, the issuer is responsible for continuing any payments, and the issuer receives any funds resulting from the payment of the death benefit.

Next, the insured transfers the existing one or more assets, rights and/or liabilities to the issuer (12). As in the previous step, this transfer may be accomplished in several ways. For example, the insured can assign the one or more assets, rights and/or liabilities to the issuer. In this case, the issuer owns these assets, rights and/or liabilities and receives any increase in value or income from these assets, rights and/or liabilities.

Subsequently, the issuer issues a Combination Life Insurance/Investment Policy to the insured, which policy has a death benefit equal to the death benefit in the existing Term Life Insurance Policy (13). The value of the Combination Life Insurance/Investment Policy is then tied to the value of the underlying one or more assets, rights or liabilities.

To pay future premiums as well as to invest additional funds in the one or more assets, rights and/or liabilities, the insured sends premium payments to the issuer in the normal manner. The Issuer then purchases more of the underlying investments, less the cost of the term insurance and any fees. As with existing combination investment/life insurance, in some cases the premiums may be paid with pre-tax funds, by deducting them from the growth in the underlying one or more assets, rights or liabilities. Moreover, the growth now occurs tax-free, as the one or more assets, rights and/or liabilities are held by the issuer rather than the insured.

As the issuer need not base the insurance on actuarial data, the issuer can charge the insured a flat fee for the overall transaction. By not requiring actuarial data and analysis, the issuer can perform the above transactions in a very cost-effective manner, thereby significantly decreasing the cost of investment style life insurance to nearly the cost of term life insurance.

Essentially, the issuer funds the cost of the term insurance from the premiums received from the insured. So, the benefits and costs of the term insurance are a wash. When the issuer receives a payment from the issuer of the term life insurance policy, the issuer of the combination investment/life insurance policy simply forwards this payment to the designated beneficiary of the combination investment/life insurance policy. When the issuer of the combination investment/life insurance policy receives a payment from the insured, the issuer of the combination investment/life insurance policy deducts its fee, pays the premium on the term life insurance policy it owns, and invests the remainder in the designated investment vehicle. If the funds received from the insured are not sufficient to pay the term life insurance policy and the fee for the issuer of the combination investment/life insurance policy, the issuer of the combination investment/life insurance policy liquidates a portion of the assets, rights and/or liabilities to make up the shortfall. If there are not sufficient assets, rights and/or liabilities to make up the shortfall, the combination investment/life insurance policy is terminated, after, of course, all required notices to the insured and opportunity to make up the shortfall, if required. Simultaneously, the issuer of the combination investment/life insurance policy terminates the term life insurance policy on the insured.

Thus, the risk to the issuer of the combination investment/life insurance policy is minimal, hence its fee can be minimal yet profitable from a transactional viewpoint. Moreover, the insured obtains the most inexpensive insurance in combination with the most advantageous form of insurance, at least from a tax viewpoint. Furthermore, the insured can replace the term life insurance component and the investment vehicle without incurring substantial penalties, other than the fee charged by the issuer, which fee can be minimal.

In a second exemplary embodiment, the insured owns existing assets, rights or liabilities but has no life insurance. In this embodiment, the issuer obtains the term insurance as part of the initial transaction, and the remaining steps remain the same. In this embodiment, the insured may either obtain the term life insurance either directly from a third party (e.g., arranged by the issuer) or through a broker. Of course, the insured may obtain the term insurance from the same party issuing the combination investment/life insurance policy.

In a third exemplary embodiment, the customer owns an existing term life insurance policy but has no assets, rights or liabilities to assign to the issuer. In this case, the insured can specify the particular assets, rights or liabilities to obtain, and the Issuer will use these specified assets, rights or liabilities for the combination investment/life insurance policy. The remaining steps continue as in the other exemplary embodiments. In this embodiment, the issuer can either obtain the specified assets/rights/liabilities or the insured can obtain them as a first step in the process.

Referring to FIG. 2, set forth therein is an exemplary embodiment of a method for replacing the individual components of an existing investment style life insurance policy, which heretofore was not possible without canceling the existing policy and potentially incurring significant transaction costs and penalties to do so. By providing the capability of replacing the individual components, the present invention enables consumers to continually take advantage of cost decreases in term life insurance. As people continue to live longer lives, term life insurance will continue to decrease in cost. Therefore, no matter what term policy one purchases now, a similar term policy will likely be cheaper later. This prevents the consumer from being locked into a policy that is unfavorable to the consumer.

Referring to FIG. 2, in this exemplary embodiment 20 the insured already owns an existing investment style life insurance policy. In this case, the insured wishes to replace the term life insurance component of the existing investment style life insurance policy or to replace the assets, rights and/or liabilities underlying the investment style life insurance policy, e.g., a Combination Life Insurance/Investment Policy. To do so, the insured transfers the existing investment style life insurance policy to the issuer (as indicated by reference numeral 21). This transfer can be accomplished in several ways, as discussed above. For example, the insured can designate the Issuer as the owner and beneficiary of the existing investment style life insurance policy.

Next, the insured transfers a new term life insurance policy or new assets, rights or liabilities to the issuer (22), depending upon the component or components the insured wishes to replace. As in the previous embodiments, this transfer may be accomplished in several ways. For example, the insured can assign the one or more assets, rights and/or liabilities to the issuer or designate the issuer as the beneficiary and owner of the term life insurance policy, again depending upon the component to be replaced.

Subsequently, the issuer issues a Combination Life Insurance/Investment Policy to the insured having a death benefit equal to the death benefit in the newly received Term Life Insurance Policy (23). The value of the Combination Life Insurance/Investment Policy is then tied to the value of the newly received assets, rights and/or liabilities as in the normal manner.

The above transaction could be further simplified by simply assigning a new term policy to the issuer and terminating the old term policy previously assigned to the issuer, in the case where the death benefit of the policy does not change or where the new term insurance does not require a change in the existing investment style life insurance policy. This could be the case where one wishes to simply replace the same term policy with a cheaper term policy without changing the death benefit.

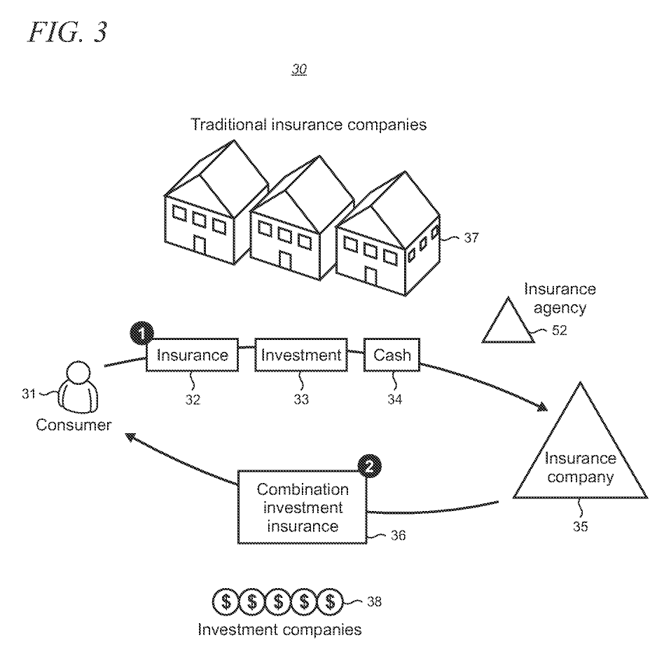

One possible transaction 30 according to one aspect of the present invention can be summed up in the block diagram of FIG. 3. The consumer 31 first transfers term insurance 32, investments 33 and cash 34 to the combination investment/life insurance issuer insurance company 35. Second, the issuer 35 issues the combination investment/life insurance policy 36 directly to the consumer 31. The consumer 31 could have previously obtained the term insurance 32 from traditional insurance companies 37 in the usual manner. In addition, the consumer could also have previously obtained the investments 33 from one or more traditional investment companies 38.

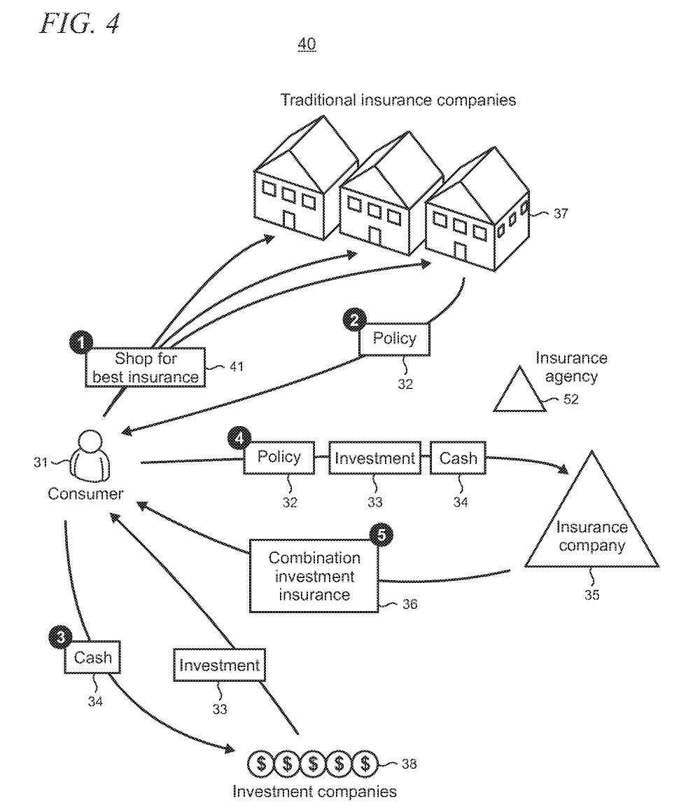

A second possible transaction 40 according to another aspect of the present invention can be summed up in the block diagram of FIG. 4. The consumer 31 first shop for the best term life insurance (as indicated by reference numeral 41) from the traditional life insurance companies 37, one of which issues the term policy 32 directly to the consumer. Next, the consumer 31 shops for investments and eventually transfers cash 42 to one or more of the investment companies 38 and receives investments 33 directly from one or more of the investment companies 38. The consumer then transfers the term policy 32, the investments 33 and cash 34 to the issuer insurance company 35, which issues the combination investment/life insurance policy 36.

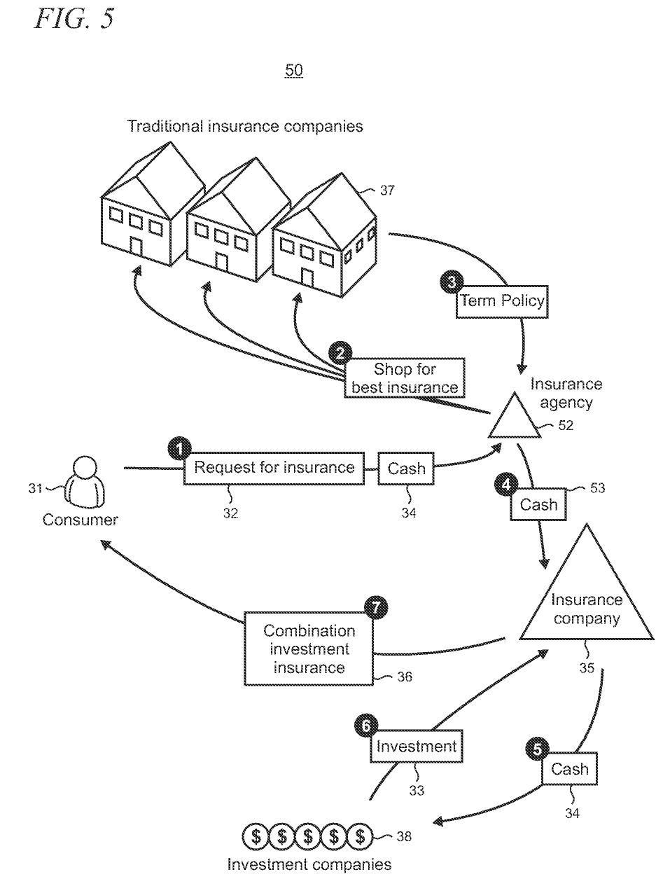

A third possible transaction 50 according to yet another aspect of the present invention can be summed up in the block diagram of FIG. 5. The consumer 31 sends a request for insurance 51 along with cash 34 to the insurance agency 52. The insurance agency 52 shops 41 for the best term life insurance from the traditional life insurance companies 37, one of which issues the term policy 32 directly to the issuer of the combination investment/life insurance policy 35. The insurance agency 52 sends cash 53 (which is part of the cash 34 transferred to the agency 52) to the issuer 35. In turn, the issuer 35 sends cash 54 (which is a portion of the cash 53 received from the agency 51 less any fees to the issuer 35) to one or more of the investment companies 38 and receives the investments 33. The issuer insurance company 35 then issues the combination investment/life insurance policy 36 to the consumer 31.

While the above-described third exemplary transaction involves a separate insurance agency and issuer, these entities could be the same. For example, the issuer could simply issue an investment style life insurance policy to the requesting insured, which provides replaceable components, i.e., replaceable investments and term life insurance.

In all of the above embodiments, the payment mechanisms can also be simplified, thereby reducing the costs of the issuer. For example, assuming the customer transferred a mutual fund and a term policy to the issuer of the investment style life insurance policy. The customer can continue to make payments directly to the mutual fund company, even though the account is in the name of the issuer, thereby avoiding the costs to the issuer normally associated with accounting and otherwise managing its fiduciary obligations with respect to the customer's money. As with any mutual fund, the customer can either send a check in or have the customer's bank account debited on a periodic basis.

The term carrier can then withdraw its premiums directly from the mutual fund account each month, quarter or premium period. The investment style life insurance issuer can also withdraw its fees in a like manner. If there remain insufficient funds to pay any of these fees or premiums, the policy is terminated in the normal manner.

Thus, the issuer can set up a business transaction in which the issuer is an insurance company but has minimal costs. The payments can be taken care of by the mutual fund company and the term carrier, thereby saving the costs of managing these transactions by the issuer.

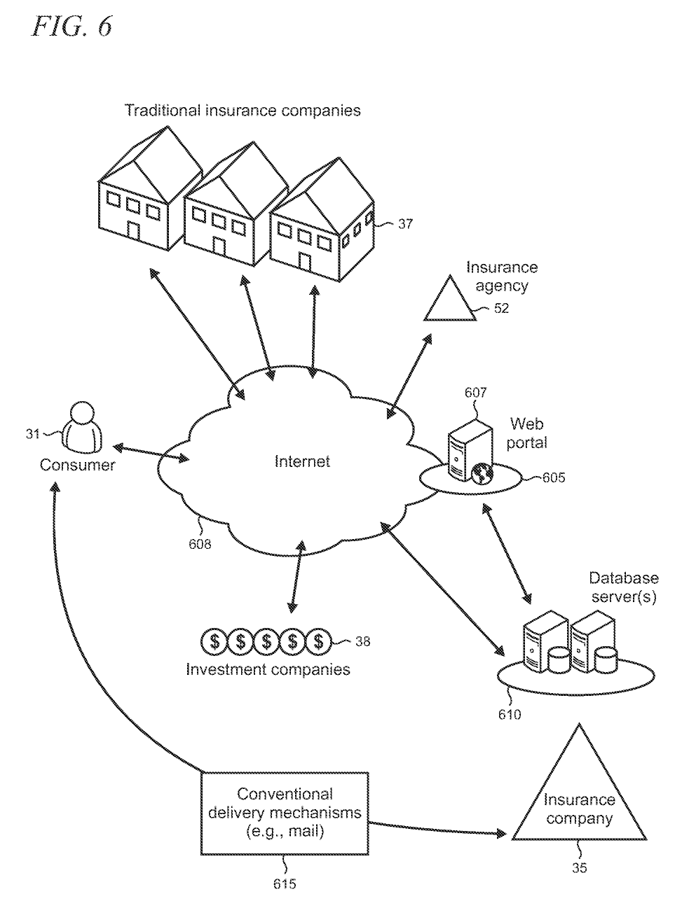

In addition as shown in FIG. 6, the issuer (e.g., insurance company 35) could establish an Internet business, in which the issuer provided a web portal 605 using a particular website hosted by a web server 607 that is accessible to the public over a network such as the Internet 608. Customers (e.g., consumer 31) accessing the website could request investment style life insurance and transfer their term policies and assets/liabilities to the issuer all via computer or electronic transactions. Assignments to the term life insurance policies and the investments could be accomplished via digital signatures and electronic messaging. Thus, the above-mentioned methods could be implemented on a computer or client-server based system. The issuer would simply issue the combination investment style life insurance policy electronically (with a copy to be sent by conventional delivery mechanisms such as mail, as indicated by reference numeral 615) for printout by the consumer. All of the above mentioned transactions can be performed by a computer receiving messages via the Internet 608 and communicating with third party insurance carriers (e.g., traditional insurance companies 37) and the investment companies 38 electronically. As the issuance of the combination investment/life insurance policy does not require underwriting, given it is backed up by the received term life insurance policy, the issuance of the combination investment/life insurance policy is relatively simple and can be completely carried out by computer without human intervention, if necessary. Thus, the server 608 could receive all ownership and assignments directly from the consumer electronically. The same or a different server could transmit the combination investment/life insurance policy electronically to the consumer 31.

The server 608 may also be utilized (typically in combination with one or more database servers 610 operated by the insurance company) so that fees relating to a transaction can be electronically deducted from the consumer's bank account. Payments to the investment companies 38 could be also made electronically. Thus, the present invention provides a completely computer implementable system that could operate with little or no human intervention to issue combination investment/life insurance policies, whose constituent elements are replaceable and controllable by the policy holder.

Thus, the present invention provides transparency for the first time to transactions involving combination investment/life insurance policies. The consumer is able to see the workings of the components of this type of life insurance. Moreover, the consumer is empowered to self-direct the various components of this type of life insurance. In addition, the present invention makes possible the existence of a life insurance issuer with low amounts of capital by leveraging the capital of other issuers.

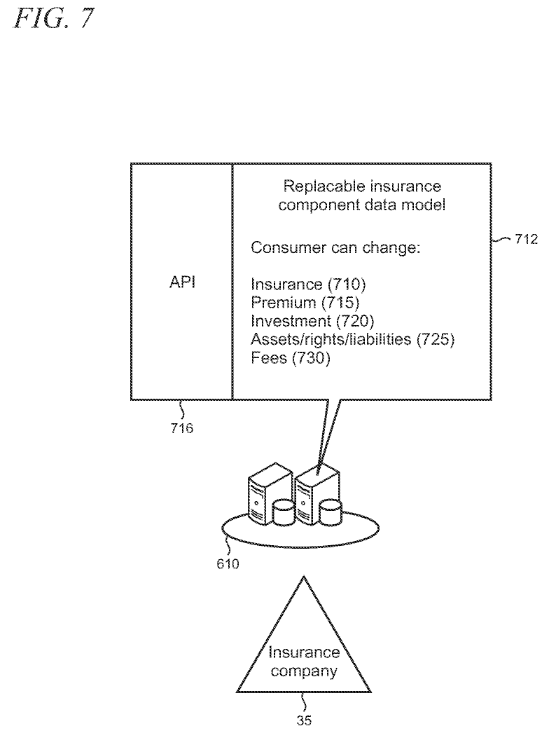

As shown in FIG. 7, the one or more database servers 610 used by the insurance company 35 will typically implement a data model 712 that enables the various component changes specified by the consumer 31 to be tracked. As shown, the data model supports tracking of the insurance policy as the consumer 31 makes changes or replacements to one or more of its components. These include, for example, the underlying term insurance (as indicated by reference numeral 710), the premium for the term insurance (715), the investment component of the policy (720), any associated assets/rights/liabilities (725), and the transaction fee (730). Accordingly, the insurance company 35 can ensure that the correct insurance coverage and investment returns are provided (and appropriate fees levied) as the consumer makes changes to the individual insurance policy components

In some implementations of the present invention, an application programming interface (“API”) is utilized to expose various methods (carried out by software running on the database servers 610) that are implemented using the data model 712. Such methods can be used, for example, by the issuer when managing the insurance policy as the consumer 31 makes changes and replacements. The methods may also exposed to the other elements shown in FIG. 6 such as the traditional insurance companies 37 and investment companies 38 to enable data to be shared with the issuer through the database servers 610 or retrieved from the database servers 610. The companies 37 and 38 may make connections to the database servers 610 via public networks like the Internet 608 using secure communication technologies such as VPN (Virtual Private Network), SSL (secure socket layers) and the like.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1-4. (canceled)

5. An automated method for managing an investment style life insurance policy having replaceable components, the method comprising the steps of:
utilizing a replaceable insurance component data model by which components are maintained in the investment style life insurance policy as being selectable by a consumer for replacement, the components including at least one of insurance, premium, investment, assets, rights, liabilities, or fees;
exposing methods for enabling replacement of the components in response to a selection by the consumer; and
tracking replacement of the components in a database.

6. The automated method of claim 5 including a further step of exposing data from the database to insurance entities over a network.

7. The automated method of claim 6 in which the insurance entities comprise at least one of traditional insurance company, investment company, or insurance agent.

8. The automated method of claim 6 in which the network comprises the Internet.

9. The automated method of claim 5 in which the exposing of methods is performed through an API.

10. The automated method of claim 5 including a further step of enabling a connection from the database to a web portal, the web portal being configured to receive the selection from the consumer.

11. The automated method of claim 10 including a further step of configuring the web portal to receive one or more electronic payments for the fees or premiums associated with the investment style life insurance policy from the consumer.

12. The automated method of claim 5 in which the insurance component of the investment style life insurance policy is configured for replacement without a need for additional underwriting.

13. The automated method of claim 5 including a further step of providing the investment style life insurance policy having replaced components to the consumer via a means of conventional delivery.

14. The automated method of claim 5 including a further step of receiving an electronic payment for the fees or premiums associated with the investment style life insurance policy from the consumer.

15. A computer-readable medium including instructions which, when executed by one or more processors disposed in an electronic device, perform a method for operating an API to a database, the method comprising the steps of:
configuring the API to expose methods for manipulating replaceable components of an investment style life insurance policy, the components being replaceable under a replaceable insurance component data model in response to selection by a consumer to whom the investment style life insurance policy is issued;
receiving a call from a caller at the API to manipulate one or more of the replaceable components of the investment style life insurance policy;
executing one or more methods to effectuate replacement of the one or more replaceable components of the investment style life insurance policy responsively to the call; and
tracking changes to the investment style life insurance policy in the database.

16. The computer-readable medium of claim 15 in which the data model includes at least one of insurance, premium, investment, assets, rights, liabilities, or fees.

17. The computer-readable medium of claim 15 in which the caller is a process operating on a web portal, the web portal being configured for facilitating the selection from the consumer for a component of the investment style life insurance policy that is to be replaced.

18. A method of enabling a consumer to effectuate a replacement of a component in an investment style life insurance policy that is configured to include replaceable components, the method comprising the steps of:
receiving a selection by the consumer of a component in the investment style life insurance policy that is to be replaced, the replaceable components including one or more of insurance, premium, investment, assets, rights, liabilities, or fees, the selection being facilitated through a portal hosted by a server on the Internet;
executing a software script that interacts with an API to a data model used to describe operations on a database, the database being configured to store changes to the investment style life insurance policy, the software script being configured to replace the component specified by the selection in an automated manner; and
providing a confirmation of a replacement of the selected component of the investment style life insurance policy, the confirmation being configured to be relayed through the portal to the consumer.

19. The method of claim 18 in which the API is configured to expose automated methods to the software script to manipulate the components of the investment style life insurance policy to effectuate the replacement.

20. The method of claim 19 in which the API is further configured to expose the automated methods to third parties including at least one of investment company, insurance company, or insurance agent via an on-line connection.

21. The method of claim 20 including a further step of generating a report that is descriptive of a current state of the investment style life insurance policy for transmission over the on-line connection to one or more of the third parties.

22. The method of claim 18 including the further steps of enabling an electronic transaction from the consumer for payment of a fee or premium associated with the investment style life insurance policy and tracking the electronic transaction in the database.

23. The method of claim 18 including a further step of configuring the software script for calculating the fee or premium responsively to the replacement of the selected component.
